(19) United States
(12) Patent Application Publication
(10) Pub. No.: US 2026/0134509 A1
(43) Pub. Date: May 14, 2026

(54) LOCAL NEUROGEOMETRIC LEARNING BASED LIGHT FIELD SUPER-RESOLUTION METHOD IN SPATIAL-ANGULAR CONTINUOUS DOMAIN

(71) Applicants: Hangzhou Dianzi University, Hangzhou (CN); Zhejiang Gongshang University, Hangzhou (CN)

(72) Inventors: Wenhui ZHOU, Hangzhou (CN); Lili LIN, Hangzhou (CN); Hua ZHANG, Hangzhou (CN); Guojun DAI, Hangzhou (CN); Qiming WANG, Hangzhou (CN); Jiahan MENG, Hangzhou (CN); Chenyu WU, Hangzhou (CN)

(73) Assignees: Hangzhou Dianzi University, Hangzhou (CN); Zhejiang Gongshang University, Hangzhou (CN)

(21) Appl. No.: 19/026,543

(22) Filed: Jan. 17, 2025

(30) Foreign Application Priority Data
Nov. 11, 2024 (CN) 202411606722.1

(51) Int. Cl. G06T 3/4053; G06T 3/4046

(52) U.S. Cl. CPC G06T 3/4053; G06T 3/4046

(57) ABSTRACT

A local neurogeometric learning based light field super-resolution method in spatial-angular continuous domain includes: S1, sending a sparse and low-resolution sub-aperture image array of the light field image into the spatial-angular aware geometric encoder module to obtain spatial-angular aware latent geometric codes; S2, sending the spatial-angular aware latent geometric codes into the local neural geometric learning module to obtain latent geometric codes of the spatial-angular continuous domain; S3, sending the latent geometric codes of the spatial-angular continuous domain into the extended rendering module to obtain a dense and high-resolution light field image; S4, setting a loss function for the neural network model; S5, using a trained neural network model to perform a light field super-resolution task test in the spatial-angular continuous domain on a test data set. The method can realize the super-resolution of the light field image in both spatial dimension and angular dimension at any scale.

### CROSS REFERENCE TO THE RELATED APPLICATIONS

This application is based upon and claims priority to Chinese Patent Application No. 202411606722.1, filed on Nov. 11, 2024, the entire contents of which are incorporated herein by reference.

### TECHNICAL FIELD

The invention relates to deep learning and computer vision technology, especially, a local neurogeometric learning based light field super-resolution method in spatial-angular continuous domain.

### BACKGROUND

The microlens-array-based light field camera records the angle and radiation information of the incident light by inserting a microlens array (MLA) between the image sensor and the main lens, thus recording the three-dimensional geometric information of the scene in terms of light space and angle. However, due to the limitation of the imaging resolution of the image sensor, there is a trade-off between the spatial resolution and the angular resolution in the light field imaging process, which makes it difficult for the spatial and angular resolution of the light field image to meet the practical application requirements. Therefore, achieving the spatial and angular super-resolution reconstruction of the light field image has become an important research task in the field of light field imaging, which reconstructs a dense and high-resolution sub-aperture image array from a sparse and low-resolution sub-aperture image array in the light field image for practical light field applications. The existing light field image super-resolution reconstruction methods have two main limitations: (1) The traditional light field image super-resolution reconstruction method is based on the light field imaging geometric model, and its performance depends on the accurate estimation of the internal parameters of the camera and the depth information of the scene. However, in practical applications, the internal parameters of the camera such as the focal length will continue to change, and the depth of the scene is difficult to obtain accurately; (2) The existing light field image super-resolution reconstruction methods can only perform super-resolution reconstruction in a single dimension of space or angle, and cannot achieve simultaneous super-resolution reconstruction of space and angle, moreover, they can only adjust the super-resolution of the light field image to a fixed scale, such as obtaining an image with twice or four times the resolution in the spatial dimension, or obtaining a sub-aperture image array of 7×7 or 9×9 in the angular dimension, and cannot achieve arbitrary resolution reconstruction in the spatial and angle continuous domains.

### SUMMARY

The purpose of the invention is to provide a local neurogeometric learning based light field super-resolution method in spatial-angular continuous domain to solve the problems existing in the above background technology.

In order to achieve the above purpose, the invention provides a local neurogeometric learning based light field super-resolution method in spatial-angular continuous domain, using a sparse and low-resolution sub-aperture image array as an input, sending the input to a neural network model to render a sub-aperture image array with arbitrary spatial and angular resolution; including the following steps:
S1, sending a sparse and low-resolution sub-aperture image array of the light field image into the spatial-angular aware geometric encoder module to obtain spatial-angular aware latent geometric codes;
S2, sending the spatial-angular aware latent geometric codes into the local neural geometric learning module to obtain latent geometric codes of the spatial-angular continuous domain;
S3, sending the latent geometric codes of the spatial-angular continuous domain into the extended rendering module to obtain a dense and high-resolution light field image;
S4, setting a loss function for the neural network model;
S5, using a trained neural network model to perform a light field super-resolution task test in the spatial-angular continuous domain on a test data set.

Preferably, in S1, inputting the sparse and low-resolution sub-aperture image array of the light field image into a convolution layer with a convolution kernel of 3×3 to obtain an initial feature map array Fᵢₙᵢₜ with a dimension of (U, V, X, Y, C), and then inputting the initial feature map array into the spatial-angular aware geometric encoder module to obtain the spatial-angular aware latent geometric codes, the spatial-angular aware geometric encoder module consists of an epipolar plane image convolution (EPIConv) module, a spatial and angular convolution (SAConv) module, and a spatial-angular aware Transformer module; for a light field image L(u, v, x, y), the EPIConv module is used to extract EPI geometric features in horizontal EPI images and vertical EPI images, the SAConv module is used to extract spatial and angular features on (x, y) and (u, v) planes, the spatial-angular aware Transformer module is used to obtain global dependencies of features obtained by the EPIConv module and the SAConv module.

Preferably, the specific step of the EPIConv module is as follows:
according to the extraction method of the horizontal EPI images, extracting V×Y horizontal EPI feature maps from Fᵢₙᵢₜ, and concatenating them into horizontal epipolar geometric features with dimension of (VY, U, X, C), recording as F_{init_h}; inputting F_{init_h} into a convolution layer with a kernel of 3×U, and then obtaining horizontal EPI features F_{epi_h} through a convolution layer with a kernel of 1×1; similarly, according to the extraction method of the vertical EPI images, extracting U×X vertical EPI feature maps from Fᵢₙᵢₜ, and concatenating them into vertical epipolar geometric features with a dimension of (UX, V, Y, C), recording as F_{init_v}; inputting F_{init_v} into a convolution layer with a kernel of 3×V and a convolution layer with a kernel of 1×1, and extracting vertical EPI features F_{epi_v}, after concatenating F_{epi_h} and F_{epi_v} on the channel dimension, inputting concatenated F_{epi_h} and F_{epi_v} into a convolution layer with a kernel of 1×1 and a convolution layer with a kernel of 3×3 to generate EPI features Fₑₚᵢ, finally, regrouping Fₑₚᵢ into feature vectors Tₑₚᵢ with a dimension of (VY, UX, C/2).

Preferably, the SAConv module consists of two feature extraction branches and a feature fusion layer, the two feature extraction branches include an upper branch and a lower branch, the upper branch is used to extract spatial features, and Fᵢₙᵢₜ is input into two convolution layers with a kernel of 3×3 to obtain spatial features Fₛₚₐ of the light field image; the lower branch is used to extract angular features, firstly, stacking the angular dimension of Fᵢₙᵢₜ into the channel dimension, and obtaining C×U×V feature maps with a size of (X, Y), recording as F_{init_ang}; then, inputting F_{init_ang} into two convolution layers with a kernel of 1×1, and generating angular features F_{ang} of the light field image; then, regrouping F_{ang} to obtain a feature array with a dimension of U×V×X×Y×C, and concatenating with Fₛₚₐ on the channel dimension to obtain composite features F_{spa_ang}, then, generating spatial-angular features Fₛₐ by using a convolution layer with a kernel of 1×1 and a convolution layer with a kernel of 3×3; finally, similar to the EPIConv module, regrouping Fₛₐ into spatial-angular feature vectors Tₛₐ with a dimension of (VY, UX, C/2).

Preferably, the spatial-angular aware Transformer module consists of an encoder Eₛ and an encoder E_{c}, the encoder Eₛ is a standard Transformer encoder with a self-attention mechanism used for obtaining global dependencies of input feature vectors, the encoder E_{c} is a cross-attention encoder that preserves epipolar geometric relevant spatial-angular features while ignoring irrelevant detail features, specifically:
firstly, concatenating Tₑₚᵢ and Tₛₐ on the channel dimension to obtain composite vectors T_{epi_sa} as the input of Eₛ, then de-concatenating the output of Eₛ into latent EPI codes Zₑₚᵢ with the same dimension as Tₑₚᵢ and enhanced spatial-angular codes T′ₛₐ with the same dimension as Tₛₐ; in the encoder E_{c}, Zₑₚᵢ are used as “query” vectors of a cross-attention mechanism, and T′ₛₐ are used as “key” vectors and “value” vectors of the cross-attention mechanism to output latent spatial-angular codes Zₛₐ with geometric significance; concatenating Zₑₚᵢ and Zₛₐ on the channel dimension to form final latent geometric codes Z_{g} with a dimension of (VY, UX, C).

Preferably, S2 specifically includes:
the local neural geometric learning module is a cascade structure consisting of a LIGF_ₕ module and a LIGF_ᵥ module, that is, it transforms the four-dimensional light field implicit function learning of the latent geometric codes Z_{g} into a cascade learning of a horizontal and a vertical light field epipolar geometric implicit functions:
according to the extraction method for the horizontal EPI images, firstly, decomposing Z_{g} into V×Y horizontal latent geometric codes Zₕ∈ [symbol] ^{U×X×C}, and then interpolating each Zₕ to a latent feature map Zₗ∈ [symbol] ^{U′×X′×c} by the local implicit image function (LIF) method; finally, regrouping all Zₗ into horizontal latent geometric codes Z′∈ [symbol] ^{U′×V×X′×Y×c}.
according to the extraction method for the vertical EPI images, firstly, decomposing Z′ into U′×X′ vertical latent geometric codes Zᵥ∈ [symbol] ^{V×Y×C}, and then interpolating each Z_{V} to a latent feature map Z′ₗ∈ [symbol] ^{V′×Y′×C} by the local implicit image function (LIIF) method; finally, regrouping all Z′ₗ into final latent geometric codes Z_{C}∈ [symbol] ^{U′×V′×X′×Y′×C}.

Preferably, S3 specifically includes:
sending final latent geometric codes Z_{C} into the extended rendering module composed of three three-dimensional convolution layers, each with a kernel of 1×1, compressing the channel number C of Z_{C} to a target output channel number c gradually, and then reconstructing a macro-pixel image I∈ [symbol] ^{U′X′×V′Y′×c}, finally, converting the reconstructed macro-pixel image into a light field sub-aperture image array

$${ℒ}_{SAIs}^{out} ∈ {ℝ}^{{U}^{′} \times {V}^{′} \times {X}^{′} \times {Y}^{′} \times c}$$

with a high spatial-angular resolution.

Preferably, the loss function in S4 uses an absolute value error (L1) between an reconstructed high spatial-angular resolution sub-aperture array image and the ground-truth high spatial-angular resolution sub-aperture array image, specifically including:
a calculation formula of a loss function Loss between the reconstructed high spatial-angular resolution sub-aperture array image

$${ℒ}_{SAIs}^{out}$$

and the ground-truth high spatial-angular resolution sub-aperture image

$${ℒ}_{SAIs}^{gt}$$

is as follows:

$$Loss = \vert {ℒ}_{SAIs}^{out} - {ℒ}_{SAIs}^{gt} \vert$$

Preferably, S5 specifically includes:
the trained local neurogeometric learning based light field super-resolution method is used to super-resolve each light field image on the test data set to a high spatial-angular resolution light field image, then using the structural similarity index (SSIM) and the peak signal to noise ratio (PSNR) to evaluate the performance of light field super-resolution.

Therefore, the invention adopts the above-mentioned local neurogeometric learning based light field super-resolution method in the spatial-angular continuous domain of light field, which has the following beneficial effects:

(1) A local neurogeometric learning based light field super-resolution method in spatial-angular continuous domain is proposed, which can achieve super-resolution of light field images in both spatial and angular dimensions at any scale.

(2) By mapping the epipolar geometry image of the light field into an interpolable latent space to learn the spatial and angular information, a spatial angle-consistent local neural geometry learning framework with simultaneous super-resolution along with the spatial-angular continuous domain.

(3) A spatial-angular aware geometric encoder is proposed to extract the latent geometric code of the epipolar geometry of the light field, integrate the local and global dependencies of the epipolar geometry of the light field, and embed the spatial-angular correlation of the light field into the latent geometric code through the spatial-angular aware cross-attention mechanism.

(4) Using the divide-and-conquer local neural geometry learning strategy, memory usage is effectively reduced by converting the four-dimensional light field implicit function learning into the cascade learning of two two-dimensional light field epipolar geometry implicit functions with shared weights.

The following is a further detailed description of the technical scheme of the invention through drawings and an embodiment.

### BRIEF DESCRIPTION OF THE DRAWINGS

FIG. 1 is a structural diagram of the local neurogeometric learning based light field super-resolution method in spatial-angular continuous domain in the embodiment of this invention.

FIG. 2 is a structural diagram of the EPIConv module structure in the invention;

FIG. 3 is a structural diagram of the SAConv module structure in the invention;

FIG. 4 is a structural diagram of the spatial-angular aware Transformer module in the invention;

FIG. 5 is the effect diagram of the embodiment in the invention.

### DETAILED DESCRIPTION OF THE EMBODIMENTS

The following detailed description of the embodiment of the invention provided in the accompanying figures is not intended to limit the scope of the invention requiring protection, but merely indicates the selected embodiment of the invention. Based on the embodiment in this invention, all other embodiments obtained by ordinary technicians in this field without making creative labor belong to the scope of protection of this invention.

The dual-plane representation of the light field image is denoted as L(u, v, x, y), where (u, v) is the angular coordinate of the light field image, and (x, y) is the spatial coordinate of the light field image, where u∈[1, U], v∈[1, V], x∈[1, X], y∈[1, Y]. L(u, v) (x, y) denotes the sub-aperture image (SAI) at a given (u, v) angle coordinate. The light field images can be seen as a set of sub-aperture image arrays.

The epipolar plane image (EPI) is obtained by stacking a row (or a column) of pixels in the same row (or the same column) of the sub-aperture image array of the light field: The coordinates of v and y in the light field image are given, a horizontal EPI image L(v, y) (u, x) can be obtained. The coordinates of u and x in the light field image are given, and a vertical EPI image L(u, x) (v, y) can be obtained. A light field image with an angular resolution of U×V and a spatial resolution of X×Y can obtain V×Y horizontal EPI images and U×X vertical EPI images.

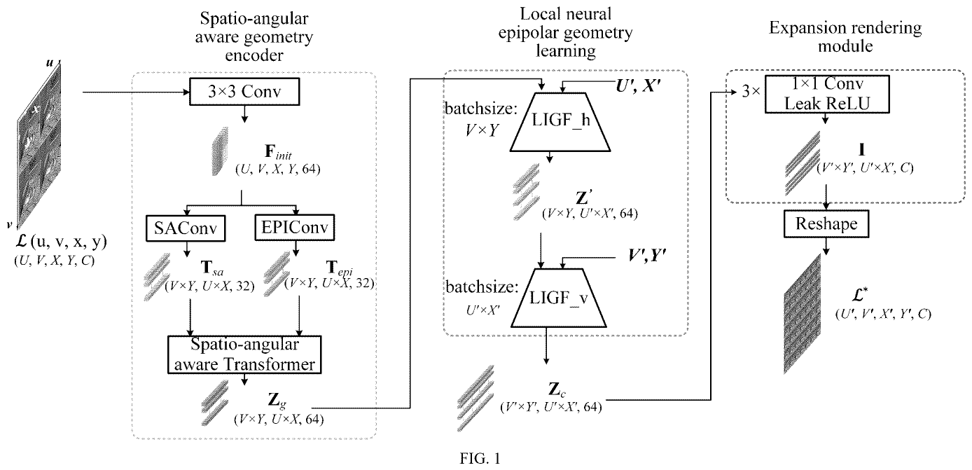

Please refer to FIG. 1, a local neurogeometric learning based light field super-resolution method in spatial-angular continuous domain, including the following steps:

S1, the sparse and low-resolution sub-aperture image array of the light field image are input into a convolution layer with a convolution kernel of 3×3 to obtain an initial feature map array Fᵢₙᵢₜ with a dimension of (U, V, X, Y, C), and then the initial feature map array are input into the spatial-angular aware geometric encoder module to obtain the spatial-angular aware latent geometric codes, the spatial-angular aware geometric encoder module consists of an EPIConv module, a SAConv module, and a spatial-angular aware Transformer module; for a light field image L(u, v, x, y), the EPIConv module is used to extract EPI geometric features in horizontal EPI images and vertical EPI images, the SAConv module is used to extract spatial and angular features on (x, y) and (u, v) planes, the spatial-angular aware Transformer module is used to obtain global dependencies of features obtained by the EPIConv module and the SAConv module.

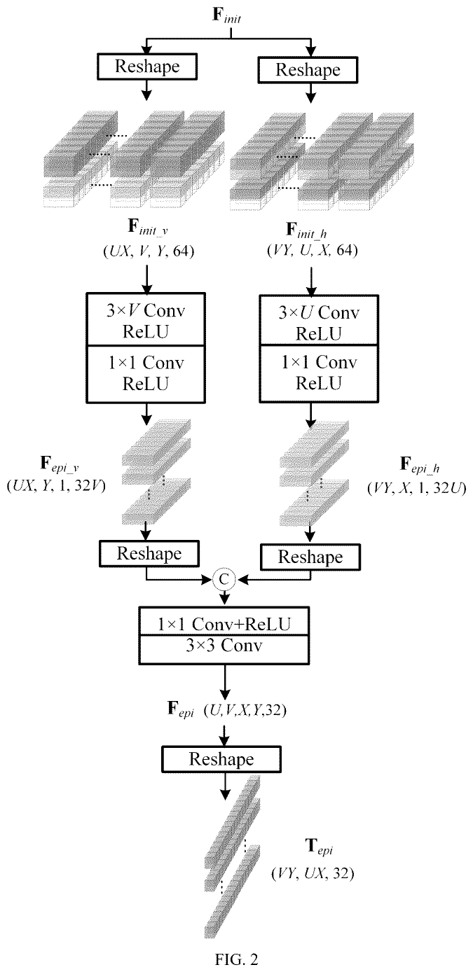

The EPIConv module, as shown in FIG. 2, according to the extraction method of the horizontal EPI images, the V×Y horizontal EPI feature maps are extracted from Fᵢₙᵢₜ, and they are concatenated into horizontal epipolar geometric features with dimension of (VY, U, X, C), recording as F_{init_h}; F_{init_h} are input into a convolution layer with a kernel of 3×U, and then the horizontal EPI features F_{epi_h} are obtained through a convolution layer with a kernel of 1×1; similarly, according to the extraction method of the vertical EPI images, U×X vertical EPI feature maps are extracted from Fᵢₙᵢₜ, and they are concatenated into vertical epipolar geometric features with a dimension of (UX, V, Y, C), recording as F_{init_v}; F_{init_v} are input into a convolution layer with a kernel of 3×V and a convolution layer with a kernel of 1×1, and extracting vertical EPI features F_{epi_v} are extracted, after concatenating F_{epi_h} and F_{epi_v} on the channel dimension, the concatenated F_{epi_h} and F_{epi_v} are input into a convolution layer with a kernel of 1×1 and a convolution layer with a kernel of 3×3 to generate EPI features Fₑₚᵢ, finally, Fₑₚᵢ is regrouped into feature vectors Tₑₚᵢ with a dimension of (VY, UX, C/2).

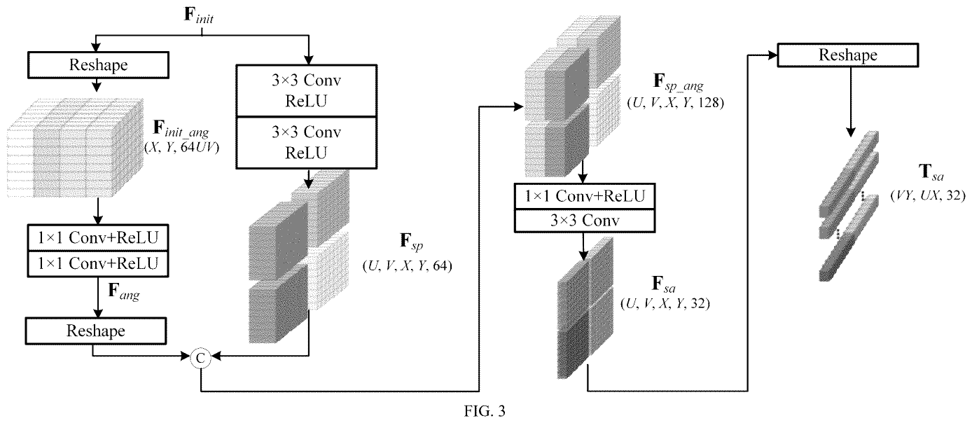

The SAConv module, as shown in FIG. 3, is used to extract and group the spatial and angular characteristics of the light field, consists of two feature extraction branches and a feature fusion layer, the two feature extraction branches include an upper branch and a lower branch, the upper branch is used to extract spatial features, and Fᵢₙᵢₜ is input into two convolution layers with a kernel of 3×3 to obtain spatial features Eₛₚₐ of the light field image; the lower branch is used to extract angular features, firstly, the angular dimension of Fᵢₙᵢₜ is stacked into the channel dimension, and C×U×V feature maps with a size of (X, Y) are obtained, recording as F_{init_ang}; then, F_{init_ang} are input into two convolution layers with a kernel of 1×1, and the angular features F_{ang} of the light field image are generated; then, F_{ang} is regrouped to obtain a feature array with a dimension of U×V×X×Y×C, and it is concatenated with Fₛₚₐ on the channel dimension to obtain composite features F_{spa_ang}, then, generating spatial-angular features Fₛₐ are generated by using a convolution layer with a kernel of 1×1 and a convolution layer with a kernel of 3×3; finally, similar to the EPIConv module, Fₛₐ is regrouped into spatial-angular feature vectors Tₛₐ with a dimension of (VY, UX, C/2).

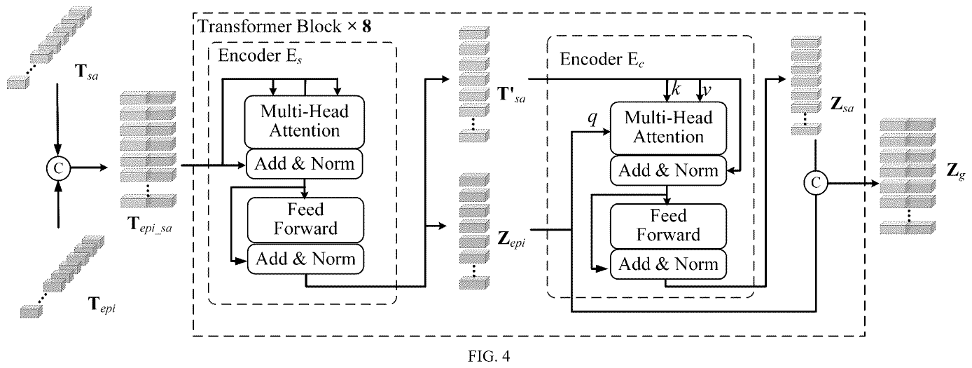

The spatial-angular aware Transformer module is used to obtain the global dependencies of the spatial, angular, and epipolar geometric features of the light field as shown in FIG. 4, the spatial-angular aware Transformer module consists of an encoder Eₛ and an encoder E_{c}, the encoder Eₛ is a standard Transformer encoder with a self-attention mechanism used for obtaining global dependencies of input feature vectors, the encoder E_{c} is a cross-attention encoder that preserves epipolar geometric relevant spatial-angular features while ignoring irrelevant detail features, specifically:
firstly, Tₑₚᵢ and Tₛₐ are concatenated on the channel dimension to obtain composite vectors T_{epi_sa} as the input of Eₛ, then the output of Eₛ is re-concatenated into latent EPI codes Zₑₚᵢ with the same dimension as Tₑₚᵢ and enhanced spatial-angular codes T′ₛₐ with the same dimension as Tₛₐ; in the encoder E_{c}, Zₑₚᵢ are used as “query” vectors of a cross-attention mechanism, and T′ₛₐ are used as “key” vectors and “value” vectors of the cross-attention mechanism to output latent spatial-angular codes Zₛₐ with geometric significance; Zₑₚᵢ and Zₛₐ are concatenated on the channel dimension to form final latent geometric codes Z_{g} with a dimension of (VY, UX, C).

S2, the spatial-angular aware latent geometric codes are sent into the local neural geometric learning module to obtain latent geometric codes of the spatial-angular continuous domain; specifically:
the local neural geometric learning module is a cascade structure consisting of a LIGF_ₕ module and a LIGF_ᵥ module, that is, it transforms the four-dimensional light field implicit function learning of the latent geometric codes Z_{g} into a cascade learning of a horizontal and a vertical light field epipolar geometric implicit functions:
according to the extraction method for the horizontal EPI images, firstly, Z_{g} is decomposed into V×Y horizontal latent geometric codes Zₕ∈ [symbol] ^{U×X×C}, and then each Zₕ is interpolated to a latent feature map Zₗ∈ [symbol] ^{U′×X′×C} by the local implicit image function (LIF) method; finally, all Zₗ are regrouped into horizontal latent geometric codes Z′∈ [symbol] ^{U′×V×X′×Y×C}.
according to the extraction method for the vertical EPI images, firstly, Z′ is decomposed into U′×X′ vertical latent geometric codes Zᵥ∈ [symbol] ^{V×Y×C}, and then each Z_{V} is interpolated to a latent feature map Z′ₗ∈ [symbol] ^{V′×Y′×C} by the local implicit image function (LIIF) method; finally, all Z′ₗ are regrouped into final latent geometric codes Z_{C}∈ [symbol] ^{U′×V′×X′×Y′×C}.

S3, the latent geometric codes of the spatial-angular continuous domain are sent into the extended rendering module to obtain a dense and high-resolution light field image; specifically:
the final latent geometric codes Z_{C} are sent into the extended rendering module composed of three three-dimensional convolution layers, each with a kernel of 1×1, the channel number C of Z_{C} is compressed to a target output channel number c gradually, and then a macro-pixel image I∈ [symbol] ^{U′X′×V′Y′×c} is reconstructed, finally, the reconstructed macro-pixel image is converted into a light field sub-aperture image array

$${ℒ}_{SAIs}^{out} ∈ {ℝ}^{{U}^{′} \times {V}^{′} \times {X}^{′} \times {Y}^{′} \times c}$$

with a high spatial-angular resolution.

S4, the network model is constructed and the loss function is set; specifically:

In this embodiment, the loss function uses an absolute value error (L1) between an reconstructed high spatial-angular resolution sub-aperture array image and the ground-truth high spatial-angular resolution sub-aperture array image, specifically including:
a calculation formula of a loss function Loss between the reconstructed high spatial-angular resolution sub-aperture array image

$${ℒ}_{SAIs}^{out}$$

and the ground-truth nigh spatial-angular resolution sub-aperture image

$${ℒ}_{SAIs}^{gt}$$

is as follows:

$$Loss = \vert {ℒ}_{SAIs}^{out} - {ℒ}_{SAIs}^{gt} \vert$$

S5, the trained neural network model is used to perform a light field super-resolution task test in the spatial-angular continuous domain on a test data set, specifically:
the trained local neurogeometric learning based light field super-resolution method is used to super-resolve each light field image on the test data set to a high spatial-angular resolution light field image, then using the structural similarity index (SSIM) and the peak signal to noise ratio (PSNR) to evaluate the performance of light field super-resolution.

Under the super-resolution task for the spatial-angular continuous domain of the light field with the angular domains from 2×2 to 5×5 and the spatial domain of 2×, the index comparison between the method of this embodiment and other methods is shown in Table 1:

TABLE 1
Comparison of indicators of different methods

| | Datasets | | | | |
|---|---|---|---|---|---|
| | 30Scenes | Occlusions | Reflective | HCIOld | EPFL |
| DistgASR + DistgSSR | 41.93/0.9920 | 38.36/0.9854 | 38.94/0.9777 | 41.56/0.9905 | 32.90/0.9695 |
| LFASR + LFSSR | 41.89/0.9919 | 38.30/0.9853 | 38.86/0.9772 | 41.72/0.9907 | 32.98/0.9692 |
| DistgASR + EPITSSR | 41.85/0.9918 | 38.27/0.9851 | 38.89/0.9768 | 42.12/0.9914 | 33.21/0.9703 |
| EASR + DistgSSR | 41.86/0.9919 | 38.21/0.9851 | 38.94/0.9776 | 41.67/0.9904 | 33.17/0.9697 |
| EASR + EPITSSR | 41.80/0.9917 | 38.15/0.9849 | 38.93/0.9774 | 42.05/0.9911 | 33.32/0.9695 |
| This invention | 41.96/0.9920 | 38.45/0.9857 | 39.12/0.9786 | 42.40/0.9920 | 33.61/0.9711 |

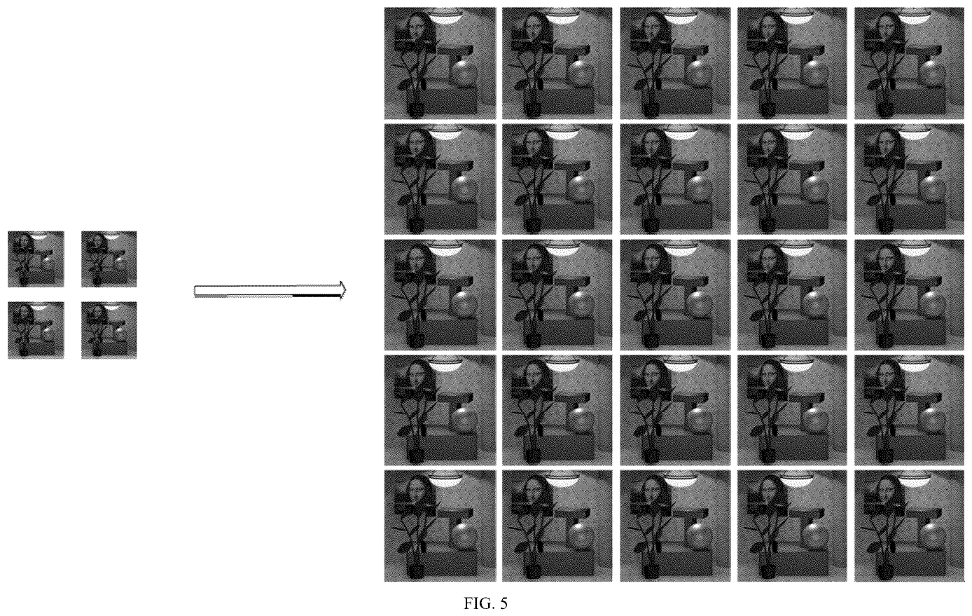

Because of the lack of existing methods that can achieve simultaneous spatial and angular super-resolution for light field images, we have to compare this method with the combinations of existing light field angular super-resolution methods (DistgASR, LFASR, EASR) and light field spatial super-resolution methods (DistgSSR, LFSSR, EPITSSR). It can be seen that this method has a good performance in multiple data sets, and the actual effect is shown in FIG. 5.

Therefore, the invention adopts the above-mentioned local neurogeometric learning based light field super-resolution method in spatial-angular continuous domain, firstly, the horizontal EPI image (or vertical EPI image) of the epipolar geometry image of the light field is obtained by stacking the pixels of a row (or column) pixel in a row (or column) of the sub-aperture image

What is claimed is:

1. A local neurogeometric learning based light field super-resolution method in a spatial-angular continuous domain, comprising the following steps:
S1, sending a sparse and low-resolution sub-aperture image array of a light field image into a spatial-angular aware geometric encoder module to obtain spatial-angular aware latent geometric codes;
S2, sending the spatial-angular aware latent geometric codes into a local neural geometric learning module to obtain latent geometric codes of the spatial-angular continuous domain;
S3, sending the latent geometric codes of the spatial-angular continuous domain into an extended rendering module to obtain a dense and high-resolution light field image;
S4, setting a loss function for a neural network model;
S5, using a trained neural network model to perform a light field super-resolution task test in the spatial-angular continuous domain on a test data set.

2. The local neurogeometric learning based light field super-resolution method according to claim 1, wherein the step S1 comprises: inputting the sparse and low-resolution sub-aperture image array of the light field image into a convolution layer with a kernel of 3×3 to obtain an initial feature map array Fᵢₙᵢₜ with a dimension of (U, V, X, Y, C), inputting the initial feature map array Fᵢₙᵢₜ into the spatial-angular aware geometric encoder module to obtain the spatial-angular aware latent geometric codes, wherein the spatial-angular aware geometric encoder module comprises an epipolar plane image convolution (EPIConv) module, a spatial and angular convolution (SAConv) module, and a spatial-angular aware Transformer module; wherein for a light field image L(u, v, x, y), the EPIConv module is configured to extract epipolar plane image (EPI) geometric features in horizontal EPI images and vertical EPI images, the SAConv module is configured to extract spatial features and angular features on (x, y) and (u, v) planes, and the spatial-angular aware Transformer module is configured to obtain global dependencies of features obtained by the EPIConv module and the SAConv module.

3. The local neurogeometric learning based light field super-resolution method according to claim 2, wherein a step of the EPIConv module is as follows:
according to an extraction method of the horizontal EPI images, extracting V×Y horizontal EPI feature maps from the initial feature map array Fᵢₙᵢₜ, concatenating the V×Y horizontal EPI feature maps into horizontal epipolar geometric features with a dimension of (VY, U, X, C), and recording as F_{init_h}; inputting the F_{init_h} into a convolution layer with a kernel of 3×U, and obtaining horizontal EPI features F_{epi_h} through a convolution layer with a kernel of 1×1; similarly, according to an extraction method of the vertical EPI images, extracting U×X vertical EPI feature maps from the initial feature map array Fᵢₙᵢₜ, concatenating the U×X vertical EPI feature maps into vertical epipolar geometric features with a dimension of (UX, V, Y, C), and recording as F_{init_v}; and inputting the F_{init_v} into a convolution layer with a kernel of 3×V and the convolution layer with the kernel of 1×1, extracting vertical EPI features F_{epi_v}, after concatenating the horizontal EPI features F_{epi_h} and the vertical EPI features F_{epi_v} on a channel dimension to obtain concatenated F_{epi_h} and F_{epi_v}, inputting the concatenated F_{epi_h} and F_{epi_v} into the convolution layer with the kernel of 1×1 and the convolution layer with the kernel of 3×3 to generate EPI features Fₑₚᵢ, and regrouping the Fₑₚᵢ into feature vectors Tₑₚᵢ with a dimension of (VY, UX, C/2).

4. The local neurogeometric learning based light field super-resolution method according to claim 3, wherein the SAConv module comprises two feature extraction branches and a feature fusion layer, the two feature extraction branches comprise an upper branch and a lower branch, the upper branch is configured to extract the spatial features Fₛₚₐ, and the initial feature map array Fᵢₙᵢₜ is input into two convolution layers with the kernel of 3×3 to obtain the spatial features Fₛₚₐ of the light field image; the lower branch is configured to extract the angular features F_{ang}; wherein an angular dimension of the initial feature map array Fᵢₙᵢₜ is stacked into the channel dimension to obtain C×U×V feature maps with a size of (X, Y), recording as F_{init_ang}; the F_{init_ang} is input into two convolution layers with the kernel of 1×1, to generate the angular features F_{ang} of the light field image; the angular features F_{ang} is regrouped to obtain a feature array with a dimension of U×V×X×Y×C, the angular features F_{ang} is concatenated with the spatial features Eₛₚₐ on the channel dimension to obtain composite features F_{spa_ang}, and spatial-angular features Fₛₐ are generated by using the convolution layer with the kernel of 1×1 and the convolution layer with the kernel of 3×3; and similar to the EPIConv module, the spatial-angular features Fₛₐ are regrouped into spatial-angular feature vectors Tₛₐ with the dimension of (VY, UX, C/2).

5. The local neurogeometric learning based light field super-resolution method according to claim 4, wherein the spatial-angular aware Transformer module comprises an encoder Eₛ and an encoder E_{c}, the encoder Eₛ is a standard Transformer encoder with a self-attention mechanism configured for obtaining global dependencies of input feature vectors, and the encoder E_{c} is a cross-attention encoder, wherein the cross-attention encoder preserves epipolar geometric relevant spatial-angular features while ignoring irrelevant detail features, comprising:
concatenating the feature vectors Tₑₚᵢ and the spatial-angular feature vectors Tₛₐ on the channel dimension to obtain composite vectors T_{epi_sa} as an input of the encoder Eₛ, de-concatenating an output of the encoder Eₛ into latent EPI codes Zₑₚᵢ with an identical dimension as the feature vectors Tₑₚᵢ and enhanced spatial-angular codes T′ₛₐ with an identical dimension as the spatial-angular feature vectors Tₛₐ; and in the encoder E_{c}, the latent EPI codes Zₑₚᵢ are used as “query” vectors of a cross-attention mechanism, and the enhanced spatial-angular codes T′ₛₐ are used as “key” vectors and “value” vectors of the cross-attention mechanism to output latent spatial-angular codes Zₛₐ with a geometric significance; and concatenating the latent EPI codes Zₑₚᵢ and the latent spatial-angular codes Zₛₐ on the channel dimension to form final latent geometric codes Z_{g} with a dimension of (VY, UX, C).

6. The local neurogeometric learning based light field super-resolution method according to claim 5, wherein the step S2 comprises:
wherein the local neural geometric learning module is a cascade structure comprising an LIGF_ₕ module and an LIGF_ᵥ module, that is, the local neural geometric learning module transforms a four-dimensional light field implicit function learning of the final latent geometric codes Z_{g} into a cascade learning of a horizontal and a vertical light field epipolar geometric implicit functions:
according to the extraction method for the horizontal EPI images, decomposing the final latent geometric codes Z_{g} into V×Y horizontal latent geometric codes Zₕ∈ [symbol] ^{U×X×C}, and interpolating each of the V×Y horizontal latent geometric codes Zₕ to a latent feature map Zₗ∈ [symbol] ^{U′×X′×C} by a local implicit image function (LIIF) method; and regrouping the latent feature map Zₗ into horizontal latent geometric codes Z′∈ [symbol] ^{U′×V×X′×Y×C}; and
according to the extraction method for the vertical EPI images, decomposing the horizontal latent geometric codes Z′ into U′×X′ vertical latent geometric codes Zᵥ∈ [symbol] ^{V×Y×C}, interpolating each of the vertical latent geometric codes Z_{V} to a latent feature map Z′ₗ∈ [symbol] ^{V′×Y′×C} by the LIIF method; and regrouping the latent feature map Z′ₗ into final latent geometric codes Z_{C}∈ [symbol] ^{U′×V′×X′×Y′×C}.

7. The local neurogeometric learning based light field super-resolution method according to claim 6, wherein the step S3 comprises:
sending the final latent geometric codes Z_{C} into the extended rendering module composed of three three-dimensional convolution layers, each of the three three-dimensional convolution layers with the kernel of 1×1, compressing a channel number C of the final latent geometric codes Z_{C} to a target output channel number c gradually, reconstructing a macro-pixel image I∈ [symbol] ^{U′X′×V′Y′×c} to obtain a reconstructed macro-pixel image, and converting the reconstructed macro-pixel image into a light field sub-aperture image array
$${ℒ}_{SAIs}^{out} ∈ {ℝ}^{{U}^{′} \times {V}^{′} \times {X}^{′} \times {Y}^{′} \times c}$$
with a high spatial-angular resolution.

8. The local neurogeometric learning based light field super-resolution method according to claim 1, wherein the loss function in the step S4 Uses an absolute value error (L1) between an reconstructed high spatial-angular resolution sub-aperture array image and a ground-truth high spatial-angular resolution sub-aperture array image, comprising:
wherein a calculation formula of the loss function Loss between the reconstructed high spatial-angular resolution sub-aperture array image
$${ℒ}_{SAIs}^{out}$$
and the ground-truth nigh spatial-angular resolution sub-aperture array image
$${ℒ}_{SAIs}^{gt}$$
is as follows:
$$Loss = \vert {ℒ}_{SAIs}^{out} - {ℒ}_{SAIs}^{gt} \vert$$

9. The local neurogeometric learning based light field super-resolution method according to claim 1, wherein the step S5 comprises:
wherein the trained neural network model is configured to super-resolve each light field image on the test data set to a high spatial-angular resolution light field image, and using a structural similarity index (SSIM) and a peak signal to noise ratio (PSNR) to evaluate performance of light field super-resolution.
